(19) United States
(12) Patent Application Publication
(10) Pub. No.: US 2015/0273583 A1
(43) Pub. Date: Oct. 1, 2015

(54) LAYER SCANNING INSPECTION SYSTEM FOR USE IN CONJUNCTION WITH AN ADDITIVE WORKPIECE FABRICATION SYSTEM

(71) Applicant: Mitutoyo Corporation, Kanagawa-ken (JP)

(72) Inventor: Jon David Bumgardner, Seattle, WA (US)

(73) Assignee: Mitutoyo Corporation, Kanagawa-ken (JP)

(21) Appl. No.: 14/229,585

(22) Filed: Mar. 28, 2014

(51) Int. Cl. B22F 3/105; B28B 1/00; B29C 67/00

(52) U.S. Cl. CPC B22F 3/1055; B29C 67/0077; B28B 1/001; B29C 67/0088; B22F 2003/1057; B29K 2105/251

(57) ABSTRACT

A layer scanning inspection system is disclosed for use in conjunction with an additive workpiece fabrication system. for providing in process layer measurement of a workpiece layer during an additive workpiece fabrication process. The additive workpiece fabrication system comprises a control portion; a layer binding portion; an elevation portion comprising a Z direction motion control portion; and a fabrication scanning motion portion. The layer scanning inspection comprises: an inspection scanning motion portion configured to scan across the current workpiece layer along a scanning direction in a manner synchronized with a layer fabrication operation sequence; a non-contact sensor arrangement that is arranged on a member of the inspection scanning motion portion; and a sensor data processing portion configured to process data acquired by the non-contact sensor arrangement as the sensing region is scanned across the current workpiece layer along the scanning direction.

### FIELD

The invention relates generally to additive fabrication systems and dimensional verification of workpieces fabricated with such systems.

### BACKGROUND

Additive fabrication systems, sometimes referred to as “3D printing” systems, are used to manufacture items through a series of layers of added material. Such systems may be distinguished from subtractive fabrication systems, wherein an item is constructed by cutting a piece of raw material into a final shape using machine tools such as lathes, milling machines, or laser cutting devices. A common type of additive fabrication system utilizes powder bed fusion. A powder bed fusion process uses thermal energy to fuse regions of a powder bed into a desired shape in order to form a workpiece. For example, a laser or electron beam may provide thermal energy to fuse or sinter a region of a layer of powder. This portion of the process is sometimes referred to as “selective laser sintering,” “electron beam melting” and “direct metal layer sintering.” After completing a layer, an elevation portion lowers the workpiece along a Z direction by a distance corresponding to one layer of thickness. A wiper or roller adds an additional layer of powder to the workpiece and the process repeats as necessary. A typical layer may have a thickness of 20-100 μm. Typical powder materials include metal, plastics and sand. An exemplary system is a Renishaw SLM 250 produced by Renishaw PLC of Gloucestershire, England.

Other forms of additive fabrication include material extrusion, binder jetting and sheet lamination. In a material extrusion process, material is dispensed through a nozzle or other orifice. For example, a thermoplastic filament may be extruded through a heated nozzle while the nozzle is rastered in an X-Y plane. This is repeated for each layer. An exemplary system is a MakerBot Replicator 2 produced by MakerBot Industries of Brooklyn, N.Y. In a binder jetting process, a liquid bonding agent is deposited to bind powdered materials. For each layer, an even layer of powder is spread over a build platform and a binder is printed in the appropriate locations for that layer. An exemplary system is a Zcorp Zprinter produced by 3D Systems of Rock Hill, S.C. In a sheet lamination process, sheets of material such as paper or metals are bonded. For each layer, a single sheet is cut into the appropriate shape for that layer and bonded to a previous layer. An exemplary system is an Mcor Iris paper based printer produced by Mcor Technologies of Dunleer, Ireland.

In various fields of fabrication technology, it is important to verify the dimensions of a fabricated workpiece. Additive fabrication is particularly advantageous for fabrication workpieces with complex internal geometry. For example, biomedical parts such as orthopedic implants and aerospace parts such as HVAC components and fuel nozzles may be advantageously fabricated with additive technology systems. Inspecting internal features of such parts can be challenging. The most common systems for inspecting complex internal features of workpieces are X-Ray and computed tomography (CT) scanners. However, such devices are high cost, provide slow measurement speed with low resolution and have power limitations which limit full penetration of certain components. Some additive fabrication systems incorporate machine vision systems into a fabrication environment to inspect layers as they are formed. Exemplary systems are disclosed in U.S. Pat. No. 7,020,539 and US Patent Publication US US20090068616 which are incorporated herein by reference in entirety. However, such systems use a single field of view from a camera that views the workpiece and have limited measurement resolution which may not be suitable for some applications. Another system for inspecting parts with complex internal features may be performed with a CGI Pearl 3D Scanner produced by CGI 3D Scanning of Eden Prairie, Minn. which utilizes a cross sectional scanning process. This system performs an inspection process by encapsulating a workpiece in epoxy and machining off 25 μm layers and imaging each layer for inspection. However, this destroys a workpiece and therefore can only be used for dimensional verification of a representative workpiece and not a part offered to a customer. There is therefore a need for an improved means for inspecting internal features of workpieces fabricated with additive fabrication techniques which economically provides a measurement of any or all fabricated workpieces with high speed and high resolution.

### BRIEF DESCRIPTION OF THE DRAWINGS

Various aspects and many of the attendant advantages of this invention will become more readily appreciated as the same become better understood by reference to the following detailed description, when taken in conjunction with the accompanying drawings, wherein:

FIG. 1 is a diagram showing an exemplary embodiment of a layer scanning inspection system for use in conjunction with a powder bed additive workpiece fabrication system;

FIG. 2 is a diagram showing an exemplary embodiment of a layer scanning inspection system for use in conjunction with a binder jetting additive workpiece fabrication system;

FIG. 3 is a diagram showing an exemplary embodiment of a layer scanning inspection system for use in conjunction with a material jetting additive workpiece fabrication system;

FIG. 4 is a diagram showing an exemplary embodiment of a layer scanning inspection system for use in conjunction with a sheet lamination additive workpiece fabrication system; and

FIG. 5 is a flow diagram showing a method for providing in process layer measurement of a workpiece layer during an additive workpiece fabrication process.

### DETAILED DESCRIPTION

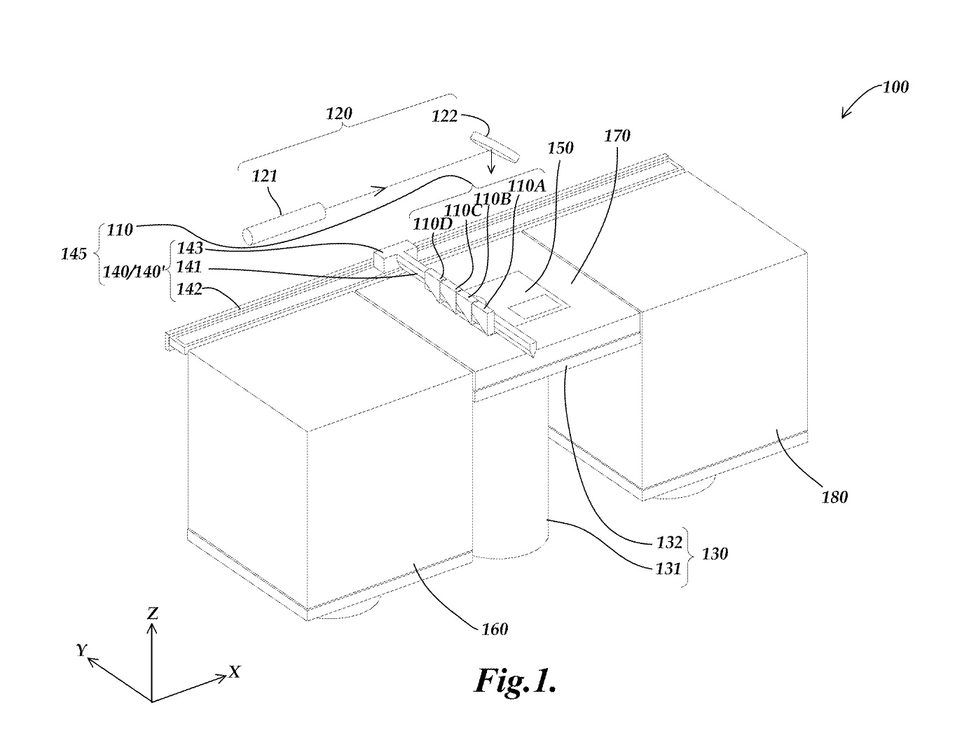

FIG. 1 is a diagram showing an exemplary embodiment of a layer scanning inspection system 145 for use in conjunction with a powder bed additive workpiece fabrication system 100. The layer scanning inspection system 145 is configured to provide in process layer measurement of a current layer during an additive workpiece fabrication process. The additive workpiece fabrication system 100 is shown in FIG. 1 as a schematic representation of a commercial system. The powder bed additive workpiece fabrication system 100 comprises a layer binding portion 120, an elevation portion 130, a fabrication scanning motion portion 140, a powder hopper 160, a powder waste containment portion 180 and a control portion (not shown). The elevation portion 130 comprises an elevation piston 131, a workpiece platform 132 and a Z direction motion control portion (not shown). The layer binding portion 120 comprises a sintering laser 121 and a steering mirror 122. The fabrication scanning motion portion 140 comprises a wiper 141 attached to a carriage 143 and a position encoder 142. The fabrication scanning motion portion 140 is configured to scan across the current workpiece layer along a scanning direction during a layer fabrication operation sequence for the current workpiece layer (e.g. to wipe or level a current layer in preparation for a fabrication operation.) In the embodiment shown in FIG. 1, the layer scanning inspection system 145 comprises an inspection scanning motion portion 140′ which in this particular embodiment comprises shared elements of the fabrication scanning motion portion 140, a non-contact sensor arrangement 110 (comprising a non-contact sensor 110A, a non-contact sensor 110B, a non-contact sensor 110C and a non-contact sensor 110D) and a sensor data processing portion (not shown). The inspection scanning motion portion 140′ is configured to scan across the workpiece layer along a scanning direction in a manner synchronized with the layer fabrication operation sequence (e.g. such that the sensor arrangement 110 senses the current layer during or after the wiper 141 has performed an operation that is part of the layer fabrication operation sequence.) The scanning direction is the −X direction in the embodiment shown in FIG. 1. The non-contact sensorS 110A-D are arranged on a member of the inspection scanning motion portion 140′ (i.e. the carriage 143) to provide a sensing region that has a first dimension that extends across a workpiece layer transverse to the scanning direction and a second dimension along the scanning direction that is smaller than a current workpiece layer. This configuration of the sensing region allows high resolution sensing, inspection and/or measurement of a workpiece layer at a relatively high speed. The sensor data processing portion is configured to process data acquired by the non-contact sensor arrangement 110 as the sensing region is scanned across the current workpiece layer along the scanning direction. In the embodiment shown in FIG. 1, the fabrication scanning motion portion 140 and the inspection scanning motion portion 140′ share common elements (e.g. motion elements and structures.) However, it should be appreciated that although this is a particularly efficient and cost-effective embodiment, it is not limiting. In some alternative embodiments, they may include separate some separate motion elements or the like, operated in a coordinated or synchronized manner, if desired.

In operation, a workpiece 150 is fabricated layer by layer. For each layer, during a layer fabrication operation sequence the wiper 141 is configured to move across the platform 132 in the +X direction and distribute powder from the powder hopper 160 in a powder bed 170, along a surface of the workpiece 150. The wiper 141 is configured to skim and deposit any excess powder into the powder waste containment portion 180 during this motion. Then, the sintering laser 121 is configured to output laser radiation at a plurality of positions in the X-Y plane along the surface of the workpiece 150, the positions determined by the steering mirror 122. This binds powder at desired locations to form a current layer of the workpiece 150. Then, the elevation portion 130 is configured to lower the workpiece 150 along the Z direction to prepare for another layer. Then, the wiper 141 is configured to move in the −X direction along the workpiece surface, while the layer scanning inspection system 145 collects workpiece layer measurement data as the sensor arrangement 110 moves across the surface of the current layer of the workpiece 150. The workpiece layer measurement data may be processed, for example, to provide a point cloud for each workpiece layer which may be used to detect material voids, and/or surface edge locations and defects. A composite or stack of the workpiece layer measurement data, in conjunction with Z direction motion control data corresponding to each layer, may be analyzed to characterize the workpiece in three dimensions.

In various embodiments, according to the principles disclosed herein, a layer scanning inspection system for use in conjunction with an additive workpiece fabrication system is configured to provide real time layer measurement of a current workpiece layer during an additive workpiece fabrication process. The additive workpiece fabrication system comprises: a control portion; a layer binding portion; an elevation portion comprising a Z direction motion control portion; and a fabrication scanning motion portion configured to scan across the workpiece layer along a scanning direction during a layer fabrication operation sequence for the current workpiece layer of the additive workpiece formation process. The layer scanning inspection system comprises: an inspection scanning motion portion configured to scan across the current workpiece layer along the scanning direction in a manner synchronized with the layer fabrication operation sequence; a non-contact sensor arrangement is arranged on a member of the inspection scanning motion portion to provide a sensing region that has a first dimension that extends across the current workpiece layer transverse to the scanning direction and a second dimension along the scanning direction that is smaller than the current workpiece layer; and a sensor data processing portion configured to process data acquired by the non-contact sensor arrangement as the sensing region is scanned across the current workpiece layer along the scanning direction.

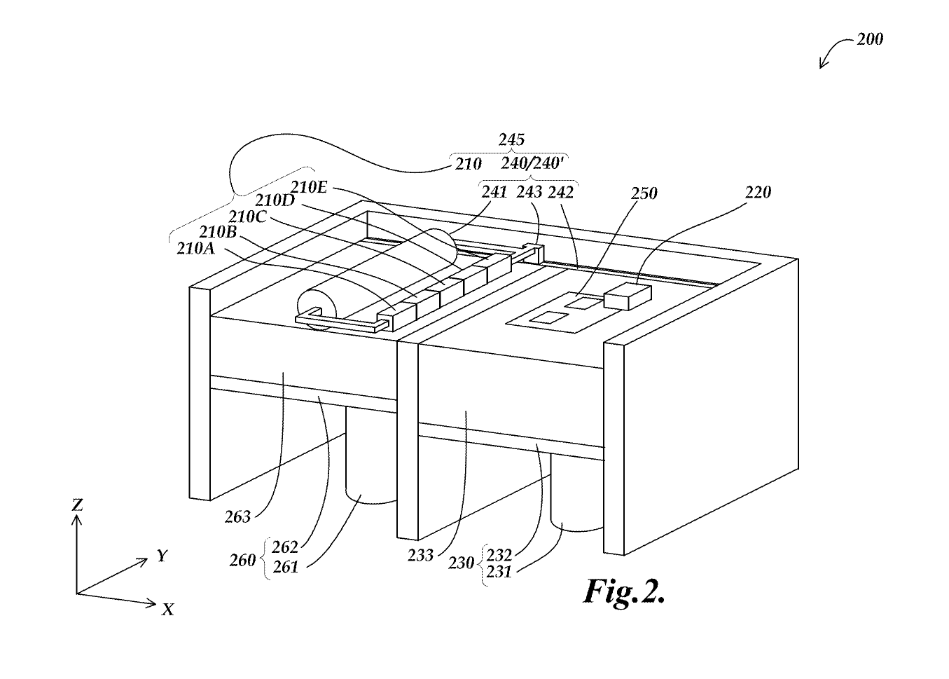

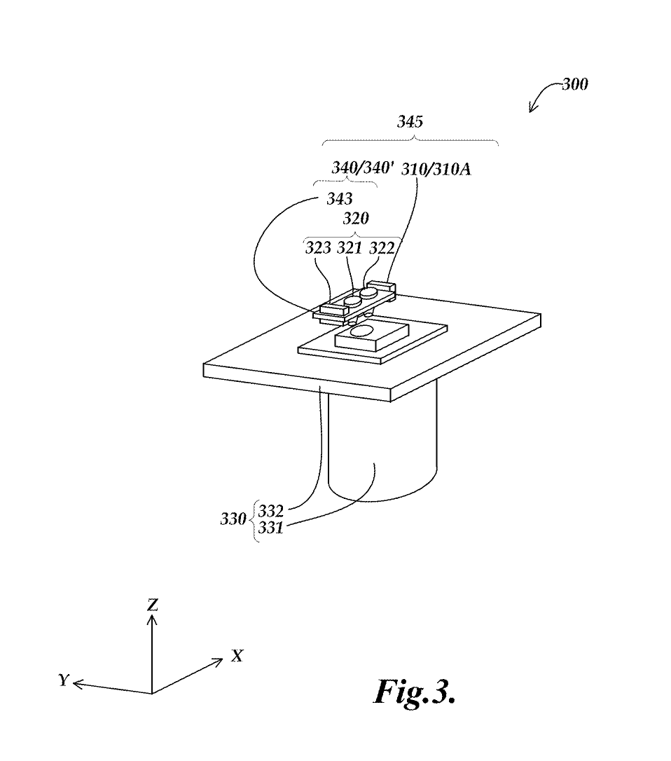

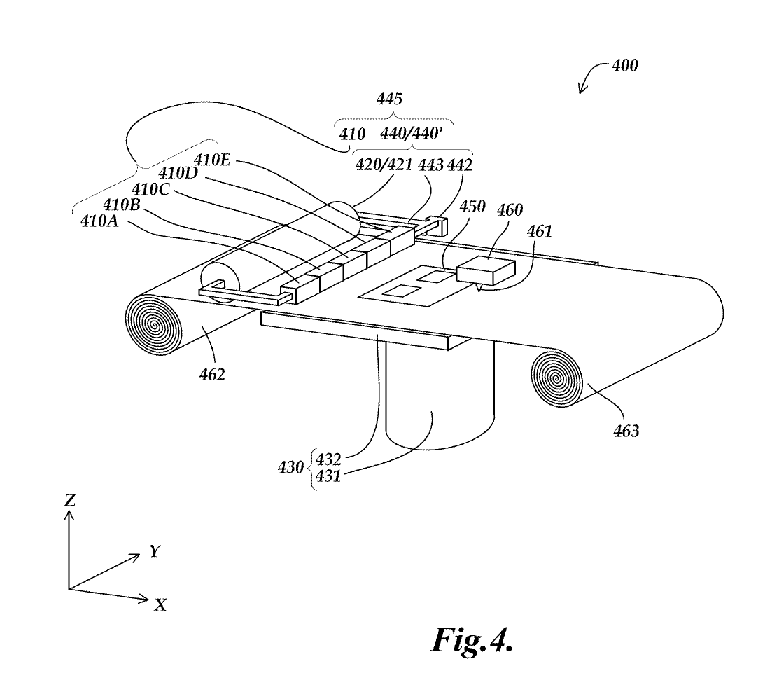

While the embodiment shown in FIG. 1 includes a fabrication scanning motion portion 140 which comprises a wiper 141, it should be appreciated than in other embodiments, a fabrication scanning motion portion may comprise a roller or a UV light, depending on the type of additive fabrication system. For example, FIG. 2 and FIG. 4 show a scanning motion control portion which comprises a roller. FIG. 3 shows a scanning motion control portion which comprises a UV light. An inspection scanning motion portion may share motion and/or structure elements with such embodiments, if desired, or may comprise separate elements.

While the embodiment in FIG. 1 includes a layer binding portion 120 which comprises a sintering laser, it should be appreciated than in other embodiments, a fabrication scanning motion portion may comprise one of: a nozzle (e.g. a material printhead) and a UV light. For example, FIG. 3 shows a layer binder portion which comprises a UV light as well as a build material printhead and a support material printhead.

In some embodiments, the non-contact sensor arrangement may comprise a plurality of sensor portions having sensor coordinates which are calibrated or registered with respect to one another and/or the inspection scanning motion portion (and/or the fabrication scanning motion portion, in the case of shared motion elements). For example, in the embodiment shown in FIG. 1, the non-contact sensors 110A-D may be calibrated with respect to one another, such that the coordinates measured by each may be transformed to a common coordinate system. In addition, the non-contact sensors 110A-D may be calibrated or registered with respect to the fabrication/inspection scanning motion portion 140/140′, such that a coordinate output by the position encoder 142 along the X direction may be expressed in a common coordinate system with coordinates measured by each of the non-contact sensors 110A-D.

In some embodiments, the sensor data processing portion may be configured to output 3D coordinates. For example, the non-contact sensors 110A-D may be configured to measure 3D coordinates of the current workpiece layer which are output by the sensor data processing portion. However, in some embodiments, the layer sensor data processing portion may be configured to output 2D coordinates and the Z direction motion control portion may be configured to output a Z direction coordinate. For example, the sensor data processing portion may be configured to output 2D coordinates from the non-contact sensors 110A-D and the layer scanning inspection system 145 may rely on the Z direction motion control portion of the elevation portion 130 to provide a Z coordinate associated with a set of 2D coordinates of a current workpiece layer.

In some embodiments, the non-contact sensor arrangement may comprise a 1D camera which has a longer dimension along the direction of the first dimension, that is, the direction transverse to the scanning direction.

In some embodiments, the non-contact sensor arrangement may comprise plurality of cameras arranged to provide a sensing region that is extended transverse to the scanning direction. In some embodiments, the non-contact sensor arrangement may comprise a plurality of 1D cameras. For example, the non-contact sensors 110A-D may be 1D cameras or 2D cameras. In some embodiments, the sensor data processing portion may be configured to process image data according to at least one of edge detection and points from focus along optical axes of respective cameras. Points from focus should be understood to refer to a method for determining a distance of a surface point along an optical axis of a camera based on a “best focus” position of a plurality of images at different focus positions. In some embodiments, the sensor data processing portion may be configured to process image data according to points from focus along optical axes of respective cameras and the plurality of cameras may be tilted with respect to a plane of the current workpiece layer such that each surface point is imaged at multiple focal distances by overlapping “tilted” sensor images during a scanning operation. It should be understood that such a system provides points from focus which provide both Z axis information and X-Y plane information. In alternative embodiments, the non-contact sensor arrangement may comprise a single camera which is a 1D camera or a 2D camera.

In some embodiments, the non-contact sensor arrangement may comprise a plurality of triangulation sensors arranged along a direction transverse to transverse to the scanning direction. For example, the non-contact sensors 110A-D may be triangulation sensors.

In various embodiments, the inspection scanning motion 140′(e.g. the fabrication scanning motion portion 140) is configured to move over more than one field of view of the non-contact sensor arrangement. For example, the inspection scanning motion portion 140 may be configured to move over more than one field of view of the non-contact sensors 110A-D. This is advantageous in comparison to systems which rely on a single stationary camera to provide machine vision operations for dimensional verification of an entire workpiece layer in that it provides for higher resolution measurement data.

In some embodiments, the first dimension (along the direction transverse to the scanning direction) may be greater than the second dimension (along the scanning direction). For example, in the embodiment shown in FIG. 1, the sensing region of the layer scanning inspection system 145 is greater along the Y direction than the X direction. In some embodiments, the non-contact sensor arrangement may be arranged to provide sensing that extends across the entire workpiece layer transverse to the scanning direction. For example, the non-contact sensors 110A-D may extend across an entire workpiece layer. This is advantageous in that for the embodiment shown in FIG. 1, layer scanning operations do not require any motion in the Y direction. However, not every additive fabrication system may be configured in such a manner due to hardware constraints.

In some embodiments, the inspection scanning motion portion comprises a position sensor which is configured to output a position coordinate corresponding to the scanning motion, and the position sensor is one of a position encoder and an interferometer. For example, FIG. 1 shows the fabrication/inspection scanning motion portion 140/140′ which comprises a position encoder 142. Alternatively, an interferometer may track a position of the wiper 141 and the layer scanning inspection system 145 in the X direction.

In some embodiments, the control portion is configured to recognize a defect and control the layer scanning inspection system to perform one of: a defect correction operation; and a cessation of the additive workpiece fabrication process. For example, a layer scanning inspection system may detect a material void in layer, in which case additional material may be added to the layer to correct the void. Alternatively, workpiece fabrication may simply cease and a defective workpiece may be abandoned in lieu of adding additional layers.

FIG. 2 is a diagram showing an exemplary embodiment of a layer scanning inspection system 245 for use in conjunction with a binder jetting additive workpiece fabrication system 200. The layer scanning inspection system 245 is configured to provide in process layer measurement of a current workpiece layer during an additive workpiece fabrication process. The additive workpiece fabrication system 200 is shown in FIG. 2 as a schematic representation of a commercial system. The binder jetting additive workpiece fabrication system 200 comprises a layer binding portion 220, an elevation portion 230, a fabrication scanning motion portion 240, a powder feed supply portion 260, and a control portion (not shown). The layer binding portion 220 is an inkjet printhead. The elevation portion 230 comprises an elevation piston 231 and a workpiece platform 232 which supports a powder bed 233. The elevation portion 230 additionally comprises a Z direction motion control portion (not shown). The powder feed supply portion comprises a powder feed piston 261 and a platform 262 configured to raise a powder supply 263 as needed. The fabrication scanning motion portion 240 comprises a leveling roller 241 attached to a carriage 243 and a position encoder 242. The fabrication scanning motion portion 240 is configured to scan across the current workpiece layer along a scanning direction during a layer fabrication operation sequence for the current workpiece layer. In the embodiment shown in FIG. 2, the layer scanning inspection system 245 comprises an inspection scanning motion portion 240′ which in this particular embodiment comprises shared elements of the fabrication scanning motion portion 240, a non-contact sensor arrangement 210 (comprising a non-contact sensor 210A, a non-contact sensor 210B, a non-contact sensor 210C, a non-contact sensor 210D and a non-contact sensor 210E) and a sensor data processing portion (not shown). The non-contact sensors 210A-E are arranged on a member of the inspection scanning motion portion to provide a sensing region that has a first dimension extends across a workpiece layer transverse to the scanning direction and a second dimension along the scanning direction that is smaller than a current workpiece layer. The inspection scanning motion portion 240′ is configured to scan across the workpiece layer along the scanning direction in a manner synchronized with the layer fabrication operation sequence. The scanning direction is the −X direction in the embodiment shown in FIG. 2. The non-contact sensor arrangement 210 is attached to the carriage 243 (along with the leveling roller 241) such that it is configured to move in a manner synchronized with the fabrication scanning motion portion 240.

In operation, a workpiece 250 is fabricated layer by layer. For each layer, the roller 241 is configured to roll from a first position across the powder supply 263 in the +X direction to a second position on the opposite end of the powder bed 233, thus spreading a layer of powder across the workpiece 250. The layer binding portion 220 is configured to print a binder along the workpiece 250 to bind a new layer. Then, the elevation portion 230 is configured to lower the workpiece 250 along the Z direction to prepare for another layer. At this point, the fabrication/inspection scanning motion portion 240/240′ (along with the roller 241) is configured to move back along the −X direction to its first position. The inspection scanning motion portion 240′, is thereby configured to scan across the workpiece layer along a scanning direction (the −X direction) in a manner synchronized with the layer fabrication operation sequence. This provides a measurement of the current layer of the workpiece 250. It should be appreciated, that in the embodiment shown in FIG. 2, the fabrication scanning motion portion 240 and the inspection scanning motion portion 240′ share common elements. However, this embodiment is exemplary only, and not limiting.

FIG. 3 is a diagram showing an exemplary embodiment of a layer scanning inspection system 345 for use in conjunction with a material jetting additive workpiece fabrication system 300. The layer scanning inspection system 345 is configured to provide in process layer measurement of a current workpiece layer during an additive workpiece fabrication process. The additive workpiece fabrication system 300 is shown in FIG. 3 as a schematic representation of a commercial system. The material jetting additive workpiece fabrication system 300 comprises a layer binding portion 320, an elevation portion 330, a fabrication scanning motion portion 340, and a control portion (not shown). The fabrication scanning motion portion 340 comprises a carriage 343 carried on various known types of X-Y position encoder and motion control components and structures (not shown) for determining positions of the components of the layer binding portion 320 and the layer scanning inspection system 345 in the X-Y plane. The layer binding portion 320 comprises a support material print head 321, a build material printhead 322 and a UV curing lamp 323, all of which are attached to the carriage 343 of the fabrication scanning motion portion 340. The elevation portion 330 comprises an elevation piston 331, a workpiece platform 332 and a Z direction motion control portion (not shown). The fabrication scanning motion portion 340 is configured to scan across the current workpiece layer along first and second scanning directions during a layer fabrication operation sequence for the current workpiece layer. The layer scanning inspection system 310 is attached to the carriage 343 of the fabrication/inspection scanning motion portion 340/340′. In the embodiment shown in FIG. 3, the layer scanning inspection system 345 comprises an inspection scanning motion portion 340′ which in this particular embodiment comprises shared elements of the fabrication scanning motion portion 340, a non-contact sensor arrangement 310 (comprising a non-contact sensor 310A) and a sensor data processing portion (not shown). The inspection scanning motion portion 340′ is configured to scan across the workpiece layer along first and second scanning directions in a manner synchronized with the layer fabrication operation sequence. The first scanning direction is the X direction in the embodiment shown in FIG. 3. It should be appreciated that a typical material jetting additive workpiece fabrication system includes a layer binding portion configured to move in both the X and Y directions. Therefore, in the embodiment shown in FIG. 3, both the X and Y directions may be understood as scanning directions, where the Y direction is a second scanning direction. The non-contact sensor 310A is arranged on a member of the inspection scanning motion portion to provide a sensing region that has a first dimension that extends across a workpiece layer transverse to the first scanning direction and a second dimension along the first scanning direction that is smaller than a current workpiece layer. The sensor data processing portion is configured to process data acquired by the non-contact sensor 310A as the sensing region is scanned across the current workpiece layer along the two scanning direction.

In operation, a workpiece 350 is fabricated layer by layer. For each layer, the layer binding portion 320 is configured to raster in the X-Y plane to a plurality of positions where the inkjet printhead 321 is configured to print build material and the inkjet printhead 322 is configured to print support material. The UV curing lamp is configured to cure the build material and support material which binds the present layer to the workpiece 350. The fabrication/inspection scanning motion portion 340/340′ is configured to move in the X-Y plane in order to obtain measurements of the present layer. The layer scanning inspection system 340′ is thereby configured to scan across the workpiece layer along a scanning direction (e.g. rastering in the X-Y plane) in a manner synchronized with the layer fabrication operation sequence. This provides a measurement of the current layer of the workpiece 350. Then, the elevation portion 130 is configured to lower the workpiece 150 along the Z direction to prepare for another layer.

FIG. 4 is a diagram showing an exemplary embodiment of a layer scanning inspection system 445 for use in conjunction with a sheet lamination additive workpiece fabrication system 400. The layer scanning inspection system 445 is configured to provide in process layer measurement of a current layer during an additive workpiece fabrication process. The additive workpiece fabrication system 400 is shown in FIG. 4 as a schematic representation of a commercial system. The sheet lamination fabrication system 400 comprises a layer binding portion 420, an elevation portion 430, a fabrication scanning motion portion 440, a cutting portion 460, a sheet feed portion 462, a sheet waste roller 463 and a control portion (not shown). The layer binding portion 420, carried on the fabrication scanning motion portion 440, comprises a heated roller 421. The elevation portion 430 comprises a piston 431, a platform 432 and a Z direction motion control portion (not shown). The fabrication scanning motion portion 440 comprises a carriage 443 and a position encoder 442. For simplicity, only a readhead of the position encoder 442 is indicated, although it should be understood that the position encoder 442 also comprises a scale track. The layer scanning inspection system 445 and the layer binding portion 420 are attached to the carriage 443 and are configured to move with it. The cutting portion 460 comprises a blade 461 (e.g. a CNC tungsten carbide blade) mounted on motion components (not shown).

The fabrication scanning motion portion 440 is configured to scan across the current workpiece layer along a scanning direction during a layer fabrication operation sequence for the current workpiece layer. In the embodiment shown in FIG. 4, the layer scanning inspection system 445 comprises an inspection scanning motion portion 440′ which in this particular embodiment comprises shared elements of the fabrication scanning motion portion 440, a non-contact sensor arrangement 410 (comprising a non-contact sensor 410A, a non-contact sensor 410B, a non-contact sensor 410C, a non-contact sensor 410D and a non-contact sensor 410E) and a sensor data processing portion (not shown). The non-contact sensors 410A-E are arranged on a member of the inspection scanning motion portion 440′ to provide a sensing region that has a first dimension that extends across the workpiece layer transverse to the scanning direction and a second dimension along the scanning direction that is smaller than a current workpiece layer. The inspection scanning motion portion 440′ is configured to scan across the workpiece layer along a scanning direction in a manner synchronized with the layer fabrication operation sequence. The scanning direction is the -X direction in the embodiment shown in FIG. 4. The sensor data processing portion is configured to process data acquired by the non-contact sensor arrangement 410 as the sensing region is scanned across the current workpiece layer along the scanning direction.

In operation, a workpiece 450 is fabricated layer by layer. For each layer, the sheet feed portion 462 is configured to feed adhesive coated paper to the platform 431 in the +X direction. The roller 421 is configured to roll from a first position across the paper on the platform 431 in the +X direction to a second position, which binds paper to the workpiece 450. The cutting portion 460 is configured move in the X-Y plane and cut the layer to a designated shape with the blade 461. The sheet waste roller 463 is configured to roll away waste paper which is not bound to the workpiece 450. Then, the elevation portion 432 is configured to lower the workpiece 450 along the Z direction to prepare for another layer. At this point, the fabrication/inspection scanning motion portion 440/440′ is configured to move back along the −X direction to its first position. The inspection scanning motion portion 440′ is thereby configured to scan across the workpiece layer along a scanning direction (the −X direction) in a manner synchronized with the layer fabrication operation sequence. It should be appreciated, that in the embodiment shown in FIG. 4, the fabrication scanning motion portion 440 and the inspection scanning motion portion 440′ share common elements. However, this embodiment is exemplary only, and not limiting.

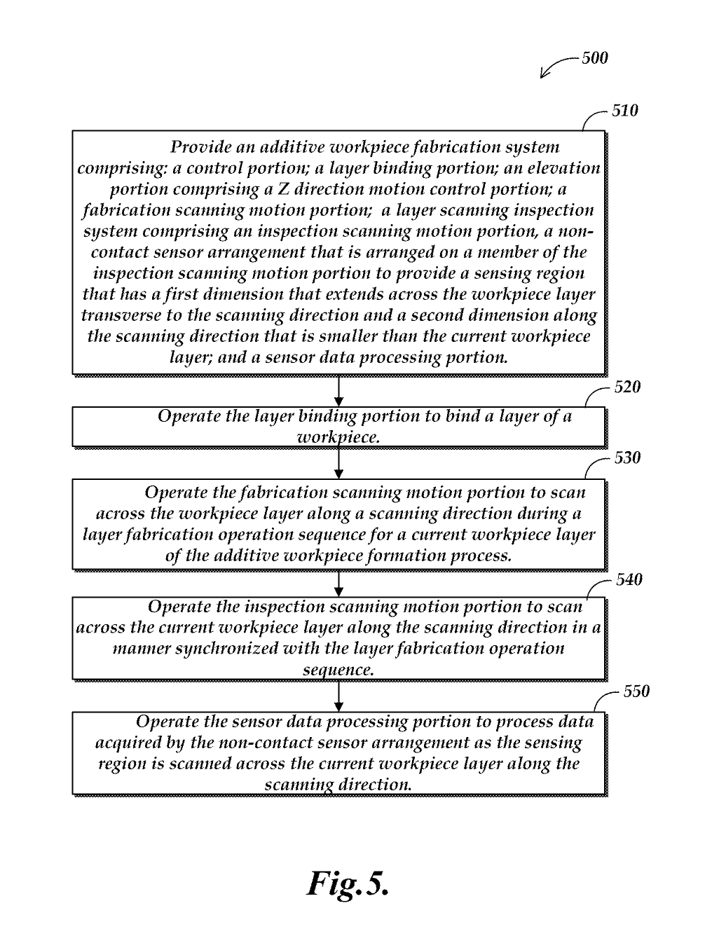

FIG. 5 is a flow diagram 500 showing a method for providing real time layer measurement of a workpiece layer during an additive workpiece fabrication process.

At a block 510, an additive workpiece fabrication system is provided, comprising: a control portion; a layer binding portion; an elevation portion comprising a Z direction motion control portion; a fabrication scanning motion portion; a layer scanning inspection system comprising an inspection scanning motion portion, a non-contact sensor arrangement that is arranged on a member of the inspection scanning motion portion to provide a sensing region that has a first dimension that extends across the workpiece layer transverse to the scanning direction and a second dimension along the scanning direction that is smaller than the current workpiece layer; and a sensor data processing portion.

At a block 520, the layer binding portion is operated to bind a layer of a workpiece.

At a block 530, the fabrication scanning motion portion is operated to scan across the workpiece layer along a scanning direction during a layer fabrication operation sequence for a current workpiece layer of the additive workpiece formation process. In some embodiments, the operations of blocks 520 and 530 may be merged and/or indistinguishable.

At a block 540, the inspection scanning motion portion is operated to scan across the current workpiece layer along the scanning direction in a manner synchronized with the layer fabrication operation sequence. In some embodiments, the scan of the block 540 may be the same as the scan of the block 530 (e.g. in some embodiments where the fabrication scanning motion portion and the inspection scanning motion portion comprise a shared motion portion.)

At a block 550, the sensor data processing portion is operated to process data acquired by the non-contact sensor arrangement as the sensing region is scanned across the current workpiece layer along the scanning direction.

While various embodiments of the invention have been illustrated and described, numerous variations in the illustrated and described arrangements of features and sequences of operations will be apparent to one skilled in the art based on this disclosure. Thus, it will be appreciated that various changes can be made therein without departing from the spirit and scope of the invention.

The embodiments of the invention in which an exclusive property or privilege is claimed are defined as follows:

1. A layer scanning inspection system for use in conjunction with an additive workpiece fabrication system, the layer scanning inspection system configured to provide in process layer measurement of a current workpiece layer during an additive workpiece fabrication process, the additive workpiece fabrication system comprising:
a control portion;
a layer binding portion;
an elevation portion comprising a Z direction motion control portion; and
a fabrication scanning motion portion configured to scan across the workpiece layer along a scanning direction during a layer fabrication operation sequence for the current workpiece layer of the additive workpiece formation process, wherein:
the layer scanning inspection system comprises:
an inspection scanning motion portion configured to scan across the current workpiece layer along the scanning direction in a manner synchronized with the layer fabrication operation sequence;
a non-contact sensor arrangement that is arranged on a member of the inspection scanning motion portion to provide a sensing region that has a first dimension that extends across the current workpiece layer transverse to the scanning direction and a second dimension along the scanning direction that is smaller than the current workpiece layer; and
a sensor data processing portion configured to process data acquired by the non-contact sensor arrangement as the sensing region is scanned across the current workpiece layer along the scanning direction.

2. The layer scanning inspection system of claim 1, wherein the fabrication scanning motion portion comprises one of: a wiper, a roller and a UV light.

3. The layer scanning inspection system of claim 1, wherein the layer binding portion comprises one of: a laser, a nozzle and a UV light.

4. The layer scanning inspection system of claim 1, wherein the non-contact sensor arrangement comprises a plurality of sensor portions having sensor coordinates which are calibrated or registered with respect to one another.

5. The layer scanning inspection system of claim 1, wherein the non-contact sensor arrangement comprises a plurality of sensor portions having sensor coordinates which are calibrated or registered with respect to the scanning motion portion.

6. The layer scanning inspection system of claim 1, wherein the sensor data processing portion is configured to output 3D coordinates of the current workpiece layer.

7. The layer scanning inspection system of claim 1, wherein the sensor data processing portion is configured to output 2D coordinates and the Z direction motion control portion is configured to output a Z direction coordinate.

8. The layer scanning inspection system of claim 1, wherein the non-contact sensor arrangement comprises a 1D camera which has a longer dimension along the direction of the first dimension.

9. The layer scanning inspection system of claim 1, wherein the non-contact sensor arrangement comprises a plurality of cameras arranged along a direction transverse to transverse to the scanning direction.

10. The layer scanning inspection system of claim 9, wherein the plurality of cameras comprises 2D cameras.

11. The layer scanning inspection system of claim 10, wherein the sensor data processing portion is configured to process image data according to at least one of edge detection and points from focus along optical axes of respective cameras.

12. The layer scanning inspection system of claim 11, wherein the sensor data processing portion is configured to process image data according to points from focus along optical axes of respective cameras and the plurality of cameras are tilted with respect to a plane of the current workpiece layer.

13. The layer scanning inspection system of claim 9, wherein the plurality of cameras comprises 1D cameras.

14. The layer scanning inspection system of claim 1, wherein the non-contact sensor arrangement comprises a plurality of triangulation sensors arranged along a direction transverse to transverse to the scanning direction.

15. The layer scanning inspection system of claim 1, wherein the scanning motion portion is configured to move over more than one field of view of the non-contact sensor arrangement.

16. The layer scanning inspection system of claim 1, wherein the first dimension is greater than the second dimension.

17. The layer scanning inspection system of claim 16, wherein the non-contact sensor arrangement is arranged to provide sensing that extends across the entire current workpiece layer transverse to the scanning direction.

18. The layer scanning inspection system of claim 1, wherein the layer scanning inspection system is configured to be used in conjunction with one of a powder bed system, a material extrusion system, a binder jetting system and a sheet lamination system.

19. The layer scanning inspection system of claim 1, wherein the scanning motion portion comprises a position sensor which is configured to output a position coordinate corresponding to the scanning motion, and the position sensor is one of a position encoder and an interferometer.

20. The layer scanning inspection system of claim 1, wherein the fabrication scanning motion portion and the inspection scanning motion portion comprise a shared motion portion.

21. The layer scanning inspection system of claim 1, wherein the sensor data processing portion is comprises a portion of the control portion.

22. The layer scanning inspection system of claim 1, wherein the control portion is configured to recognize a defect and control the layer scanning inspection system to perform one of:
a defect correction operation; and
a cessation of workpiece fabrication.

23. A method for providing in process layer measurement of a workpiece layer during an additive workpiece fabrication process, the method comprising:
providing an additive workpiece fabrication system comprising:
a control portion;
a layer binding portion;
an elevation portion comprising a Z direction motion control portion;
a fabrication scanning motion portion;
a layer scanning inspection system comprising an inspection scanning motion portion, a non-contact sensor arrangement that is arranged on a member of the inspection scanning motion portion to provide a sensing region that has a first dimension that extends across the workpiece layer transverse to the scanning direction and a second dimension along the scanning direction that is smaller than the current workpiece layer; and
a sensor data processing portion,
operating the layer binding portion to bind a layer of a workpiece;
operating the fabrication scanning motion portion to scan across the workpiece layer along a scanning direction during a layer fabrication operation sequence for a current workpiece layer of the additive workpiece formation process;
operating the inspection scanning motion portion to scan across the current workpiece layer along the scanning direction in a manner synchronized with the layer fabrication operation sequence; and
operating the sensor data processing portion to process data acquired by the non-contact sensor arrangement as the sensing region is scanned across the current workpiece layer along the scanning direction.
